(19) United States
(12) Patent Application Publication
(10) Pub. No.: US 2016/0162952 A1
(43) Pub. Date: Jun. 9, 2016

(54) ENTITY RELATIONSHIP MANAGEMENT SYSTEM

(71) Applicant: AT&T Intellectual Property I, L.P., Atlanta, GA (US)

(72) Inventor: James Carlton BEDINGFIELD, SR., Gainesville, GA (US)

(21) Appl. No.: 14/560,928

(22) Filed: Dec. 4, 2014

(51) Int. Cl. G06Q 30/02

(52) U.S. Cl. CPC G06Q 30/0269

(57) ABSTRACT

Methods, non-transitory computer readable media and devices are disclosed for recommending an alteration to a second relationship based upon an event relating to a first relationship. For example, a method includes a processor for receiving an authorization to manage a plurality of relationships of a user, for detecting an event relating to a first relationship of the plurality of relationships, and for providing a recommendation to alter a second relationship of the plurality of relationships based on the event.

The present disclosure relates generally to relationship management systems and, more particularly, to a method, computer readable medium, and device for recommending an alteration to a second relationship based upon a detected event relating to a first relationship of a user.

### BACKGROUND

Many aspects of everyday life involve functional relationships between entities, including the establishment, modification, and deletion of those relationships, and the management of their functions. Innovations in technology and business systems are bringing about new and more complex forms of relationships. Shared ownership, reverse mortgages, music streaming services, hourly car rentals, open-source software, wikis, Creative Commons and other licensing services, and self-driving vehicles are just a few examples of this new complexity. The need for authentication, authorization, privacy, and security services also produces more complex relationships. Finally, a variety of legal agreements, formal and ad hoc, produced by governmental and business entities, have already reached the “click and hope” state—most users simply click “I agree” and hope nothing in the agreements will later be a cause for regret.

### SUMMARY

In one embodiment, the present disclosure provides a method, computer readable medium, and device for recommending an alteration to a second relationship based upon an event relating to a first relationship. For example, a method includes a processor for receiving an authorization to manage a plurality of relationships of a user, for detecting an event relating to a first relationship of the plurality of relationships, and for providing a recommendation to alter a second relationship of the plurality of relationships based on the event.

### BRIEF DESCRIPTION OF THE DRAWINGS

The present disclosure can be readily understood by considering the following detailed description in conjunction with the accompanying drawings, in which:

FIG. 1 illustrates one example of a system comprising different entity relationship management systems (ERMSs), according to the present disclosure;

FIG. 2 illustrates one example of a communication network of the present disclosure;

FIG. 3 illustrates example screen views of an application for recommending an alteration to a second relationship based upon an event relating to a first relationship, according to the present disclosure;

FIG. 4 illustrates an example flowchart of a method for recommending an alteration to a second relationship based upon an event relating to a first relationship, according to the present disclosure; and

FIG. 5 illustrates a high-level block diagram of a computing device specially programmed for use in performing the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer readable storage media, and devices for managing a plurality of relationships for a user, and more specifically to recommending an alteration to a second relationship based upon an event relating to a first relationship of the user. In one example, the present disclosure provides an entity relationship management system (ERMS) for a user, e.g., an application server (AS) that is authorized to manage a plurality of relationships of the user with various other entities. In one example, the user's ERMS uses information associated with the relationship between the user and one of the entities to make a suggestion, prediction or take automatic action with respect to the relationship between the user and one of the other entities. Each of the entities may also have an ERMS for providing access to data relevant to the relationship between the user and the entity, and for receiving instructions, notifications and other information from the user's ERMS relating to the relationship. For example, the user's ERMS may be authorized to manage the user's relationships with the user's employer, one or more governmental agencies, the user's life insurance company, the user's car insurance company, the user's homeowner's insurance company, the user's gym, the user's educational institution, and so forth.

To illustrate, in one example the user's ERMS may access information regarding the user's salary from tax records obtained from the US government's ERMS or may access salary information from the ERMS of the user's employer. The salary information may indicate that the user has a current salary of ‘X’, which is double the user's previous salary of ‘Y’. The salary information may then be provided to the ERMS of the user's life insurance company. In turn, the life insurance company may determine that based upon the user's new salary, in conjunction with previous information regarding the user, that the user is underinsured. Thus, the ERMS for the life insurance company may suggest to the user, via the user's ERMS, that the user should increase his or her life insurance coverage.

In another example, the ERMS for the user's life insurance company may notify the ERMS of the user that a new discount is offered to users who visit the gym more than 120 days per year. The ERMS may query the ERMS for the user's gym to determine that the user has already attended 110 days for the year as of December 1. The user's ERMS may then suggest that the user attend the gym at least 10 days in December, which will qualify the user for the discount from the life insurance company.

In another example, the ERMS for the user's car insurance company may make known to the user's ERMS that discounts are available to customers with graduate degrees. The user's ERMS may then determine from the ERMS of the user's graduate school that the user recently graduated and received his or her master's degree. In this case, the user's ERMS may suggest that the user contact the car insurance company to request the discount. Alternatively, the user's ERMS may automatically provide this information to the ERMS of the car insurance company and automatically request the discount.

In all examples of the present disclosure, the user's ERMS leverages information regarding one of the user's relationships to make a prediction, to make a suggestion, or to take an automated action regarding one of the user's other relationships. In one example, the present disclosure further includes a desktop or mobile phone application that works in conjunction with the user's EMRS to provide visual indications on a device screen to notify the user that there is a relationship with some entity that may require attention. For example, if the ERMS detects that the user qualifies for a car insurance discount after finishing graduate school, the ERMS may provide a button on the screen which, when clicked, may provide the reason for the notification, e.g., an explanation of why the user qualifies for the discount with a suggestion to contact the car insurance company.

In one example, one or more ERMSs may be embodied by one or more application servers managed by a telecommunications network service provider on behalf of various users and other entities. In one example, different entities may also host their own ERMSs, e.g., an insurance company may provide an ERMS on an application server within its own corporate network. In one example, the user's ERMS is only authorized to manage those relationships that the user has designated. In addition, the user may specify that the user's ERMS may only share information from certain relationships with respect to certain other relationships. For instance, the user may allow his or her medical insurance information to be shared with his or her life insurance company's ERMS, but may not wish this information to be shared with his or her employer's ERMS. In one example, data from various entities are organized in standard formats such that the user's ERMS and the ERMSs of the various entities may interact, share data, and make predictions, make suggestions and take automated actions.

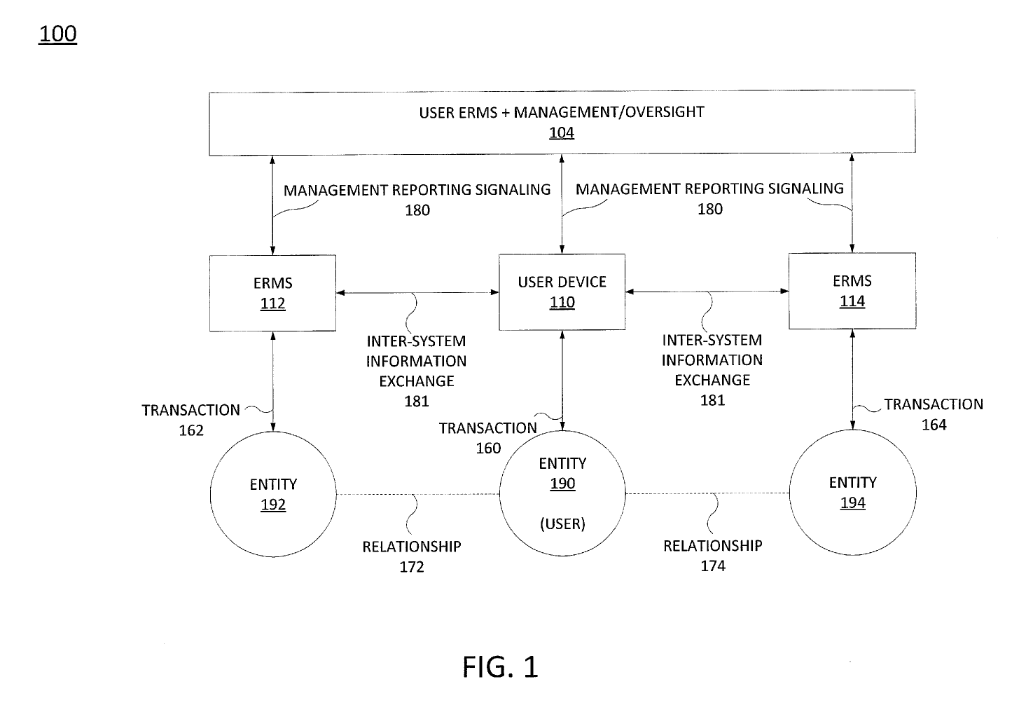

FIG. 1 illustrates a functional diagram of an example system 100 comprising a plurality of different entity relationship management systems (ERMSs). In particular, system 100 includes a user ERMS 104, which may also provide management and oversight functions. Notably, in one example, the user EMRS 104 may provide EMRS functions for a plurality of users. For instance, user EMRS 104 may comprise one or more application servers hosted by a telecommunications network service provider for various users and/or subscribers. With respect to a particular user, e.g., “entity”/user 190, the user EMRS 104 communicates with a user device 110 to perform various task relating to the present disclosure, such as: receiving event notifications relating to one or more of the user's relationships (e.g., including relationships 172 and 174), providing recommendations for alterations to a second relationship based upon an event detected regarding a first relationship, receiving from the user device 110 authorizations to utilize information from a first relationship with respect to a second relationship and authorizations to request alterations to the second relationship, and so forth.

User ERMS 104 also communicates with ERMSs 112 and 114 for at least a first entity 192 and a second entity 194 respectively. As indicated in FIG. 1, user 190 has relationships (172 and 174) with entities 192 and 194 respectively. For example, entities 192 and 194 may respectively comprise the user's life, car, home, heath or disability insurance company, the user's gym, a governmental agency, a civic organization, the user's educational institution, the user's employer, and so forth. User ERMS 104 communicates with ERMS 112 and ERMS 114 for at least the tasks of: detecting/receiving information regarding events that pertain to the relationships of the user with the respective ERMSs 112 and 114, forwarding information pertaining to an event received from a first of the ERMS 112 and 114 to a second of the ERMSs 112 and 114, receiving a response from the second ERMS, and sending a request to the second ERMS to alter a relationship based upon the event detected with respect to the first ERMS.

As illustrated in FIG. 1, the user ERMS 104 can detect an event in various ways. For example, entity 192 may interact with the ERMS 112 via a transaction 162 to indicate an event pertaining to relationship 172. Similarly, entity 194 may interact with the ERMS 114 via a transaction 164 to indicate another event pertaining to relationship 174. In turn, ERMSs 112 and 114 may notify user ERMS 104 via management and reporting signaling 180. Alternatively, or in addition, the user 190 may notify ERMS 104 of various events relating to relationships 172 and 174 via user device 110 and a transaction 160. User device 110 may then forward notification(s) of the event(s) via management and reporting signaling 180 to user ERMS 104. Thus, for example, if entity 192 comprises an educational institution of user 190, when the user graduates, this event may be notified to the user ERMS 104 via the educational institution's ERMS 112, or by the user 190 via the user device 110.

Notably, user device 110 and ERMSs 112 and 114 may also provide event notifications, transmit and receive requests to alter relationships, and send and receive other information directly amongst one another without passing through user ERMS 104. For example, if entity 194 comprises the user's employer, a notification of a paycheck deposit into the user's account may be sent from ERMS 114 to the user device 110, but may also be provided to user ERMS 104. Thus, FIG. 1 illustrates modes of inter-system information exchange 181 for direct communications between user device 110 and ERMSs 112 and 114.

It should also be noted that in one example, ERMS 104 may be integrated within user device 110. However, in the example of FIG. 1 user ERMS 104 is advantageously a separate device, e.g., an application server, and may manage relationships for a plurality of different users. For instance, User ERMS 104 may implement separate instructions for managing diverse relationships of various users according to the different preferences of each user. Similarly, in another embodiment ERMS 112 and/or ERMS 114 may be integrated within the same device as user ERMS 104. For example, a single device or a cluster of devices operating as a single functional entity may implement programs, logic and/or instructions for multiple ERMSs associated with different entities.

In one embodiment, the user ERMS 104 may comprise part of a device that includes management and oversight functions with respect to relationship management system 100. In particular, in order for the user ERMS 104 to make a suggestion or prediction, or to take an automatic action with respect to one of the relationships 172 or 174, the ERMSs should send and receive information in a defined format that is expected and understood by each of the ERMSs.

For example, the user ERMS 104 may maintain a profile of the user with a number of fields populated with values in standard format, e.g., characters, strings, integers, floating point numbers, etc. The fields may relate to a name of the user, an address, which may be contained within a single field or several fields for a street, a town, a zip code, a state, etc., an age, a marital status, an employment status, employer information, e.g., the name of the employer, the location of the employment, the type of position, e.g., full-time, part-time, contract, etc., a salary, a job title, educational information, such as an educational level attained, the names of one or more of the educational institutions attended by the user, professional certifications and statuses, vehicle related information, e.g., number of years driving, type(s) of vehicles owned and accident history information, home information, e.g., information on whether the user owns or rents a home, an address of the property, a purchase price, an appraised value, a number of bedrooms and bathrooms, a square footage of living area and a total square footage of the property, zoning information, health related information, such as any diagnoses, height, weight, body-mass-index (BMI), medical history information, including dates of doctor visits, prescription information, and so on.

Notably, much of the information contained in the user profile relates to insurance information, which is a highly regulated field. As such, much of the information that may be contained in a user profile is already collected and stored in standard formats by the various insurance companies. For example, although an automobile insurance policy, a homeowner's insurance policy, a life insurance policy, or a disability insurance policy may contain 20-30 pages or more, a one-two page binder is often sufficient to convey the full extent of the benefits and obligations of the user and the insurer under the policy. In addition, an insurance quote can often be obtained over the phone by the user answering a reasonable number of questions, which an insurance agent can use to generate a quote in a matter of minutes. The information required by various competing insurers is typically the same or significantly overlaps with the information required by other insurers. Thus, a user profile of user 190 that contains all of the most typical information relating to various types of insurance can be stored by user ERMS 104 and updated via interactions with user device 110 and ERMSs of one or more insurers, e.g., ERMS 112 and/or ERMS 114.

Similarly, employment information such as job title, salary, the name and location of the employer, and so on, are typically found in a user's tax return as well as in the user's pay stubs. Notably, each of these documents has become standardized electronically such that the document can be characterized as a series of fields populated with respective values. For instance, different vendors provide federal tax return software, yet the requirements for different fields are the same, such that the U.S. Treasury receives electronic tax returns in a standard format. W-2 wage statements, I-9 employment verification forms, and other similar forms are also standardized and can be created, transmitted, scanned, searched, and otherwise viewed or manipulated in an electronic format. Paychecks are also printed automatically and in bulk by an employer or third-party paycheck provider for numerous employees. Thus, a user profile of user 190 containing all of the most typical information relating to salary and employment information can be stored by the user ERMS 104 and updated via interactions with the user device 110 and ERMSs of one or more insurers, e.g., ERMS 112 and/or ERMS 114.

In addition to the foregoing, the user 190 may also add, delete, change or update various information stored by user ERMS 104 relating to the user 190 and his or her relationships, e.g., including relationships 172 and 174, via user device 110.

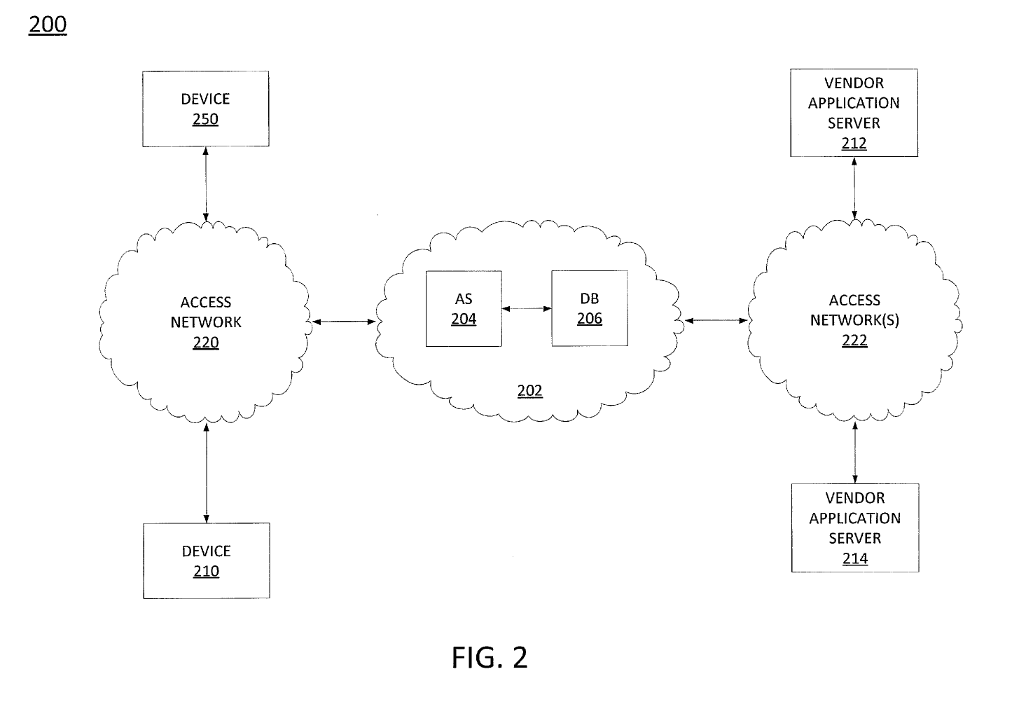

To further aid in understanding the present disclosure, FIG. 2 is a block diagram depicting one example of a communication network 200. The communication network 200 may be any type of communication network, such as for example, a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, and the like related to the current disclosure. It should be noted that an IP network is broadly defined as a network that uses Internet Protocol to exchange data packets. Additional exemplary IP networks include Voice over IP (VoIP) networks, Service over IP (SoIP) networks, and the like.

In one embodiment, the network 200 may comprise a core network 202. The core network 202 may be in communication with one or more access networks 220 and 222. The access networks 220 and 222 may include a wireless access network (e.g., an IEEE 802.11/Wireless Fidelity (Wi-Fi) network and the like), a cellular access network, a PSTN access network, a cable access network, a metropolitan area network (MAN), other types of wired access networks, and the like. In one embodiment, the access networks 220 and 222 may all be different types of access networks, may all be the same type of access network, or some access networks may be the same type of access network and other may be different types of access networks. In embodiment, the core network 202 may be operated by a communication network service provider. The core network 202 and the access networks 220 and 222 may be operated by different service providers, the same service provider or a combination thereof, or may be operated by entities having core businesses that are not related to telecommunications services, e.g., corporate, governmental or educational institution LANs, and the like.

In one embodiment, the core network 202 may include an application server (AS) 204 and a database (DB) 206. Although only a single AS 204 and a single DB 206 are illustrated, it should be noted that any number of application servers 204 or databases 206 may be deployed.

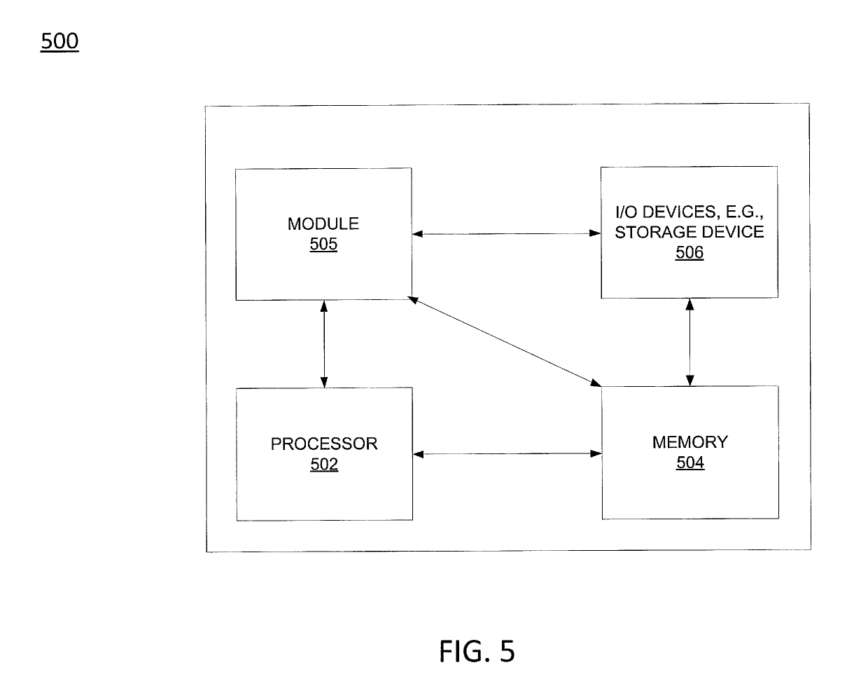

In one embodiment, the AS 204 may comprise a specialized computer as illustrated in FIG. 5 and discussed below. In one embodiment, the DB 206 may store personal information of the subscribers of the communication network 200, such as the subscribers' user identification (uid), public and private key information, encryption and decryption keys, and the like. In one example, DB 206 also stores user profile information in connection with one or more entity relationship management systems (ERMSs) for one or more users. In this regard, DB 206 may also store programs, logic or instructions that may be executed by AS 204 for providing ERMS functions for the one or more users. Notably, AS 204 may correspond to the user ERMS 104 illustrated in FIG. 1 and discussed above.

In one embodiment, the access network 220 may be in communication with one or more devices 210 and 250. In one embodiment, each of devices 210 and 250 may comprise any single device or combination of devices that comprise a user device. For example, devices 210 and 250 may correspond to user device 110 in FIG. 1. As such, the devices 210 and 250 may each comprise a mobile device, a cellular smart phone, a laptop, a tablet computer, a desktop computer, an application server, a bank or cluster of such devices, and the like. In one example, devices 210 and 250 may each comprise programs, logic or instructions for providing a relationship management interface in accordance with the present disclosure. As such, devices 210 and 250 may interact with AS 104 in order to provide such relationship management functions. In one example, each of devices 210 and 250 may also comprise a specialized computer as illustrated in FIG. 5 and discussed below.

In one embodiment, the access network 222 may be in communication with one or more vendor application servers 212 and 214. Each of the vendor application servers 212 and 214 may be associated with, for example, a financial institution, a governmental agency, an insurer, an employer, a gym, and so forth. For example, vendor application servers 212 and 214 may implement ERMS 112 and 114, respectively in FIG. 1. In one embodiment, the vendor application servers 212 and 214 may need to process, e.g., send, receive, store, modify or otherwise utilize information pertaining to a relationship with a user. For example, vendor application servers 212 and 214 may communicate with AS 104, device 110, device 150, and so forth, regarding events relating to a relationship with a user, and actions pertaining to a different relationship of the user in response to such events. In one embodiment, the access network 222 is connected to one or more computers or local networks of the respective vendors associated with vendor application servers 212 and 214. In one example, each of vendor application servers 212 and 214 may also comprise a specialized computer as illustrated in FIG. 5 and discussed below.

It should be noted that the network 200 has been simplified. For example, the network 200 may include other network elements (not shown) such as border elements, routers, switches, policy servers, security devices, gateways, a content distribution network (CDN) and the like. Similarly, although only two access networks, 220 and 222 are shown, in other examples, access networks 220 and/or 222 may each comprise a plurality of different access networks that may interface with core network 202 independently or in a chained manner. For example, vendor application server 212 and vendor application server 214 may access core network 202 via different access networks.

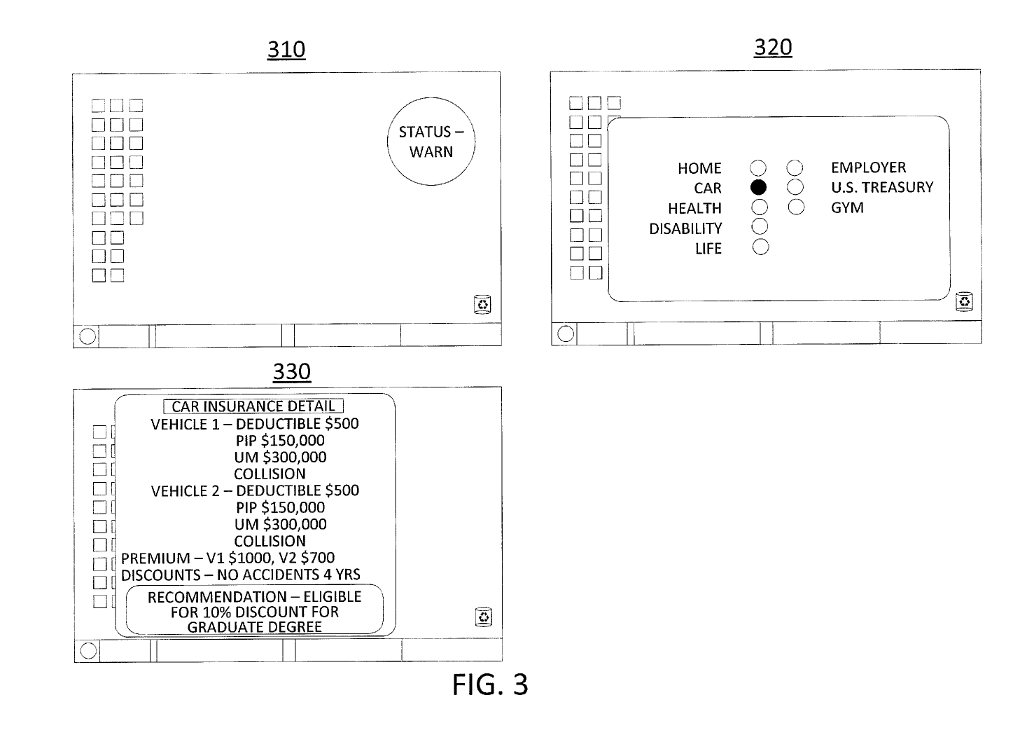

To further aid in understanding the present disclosure, FIG. 3 illustrates examples of a user interface for an entity relationship management application provided by a user device. Image 310 illustrates an example of what may be presented on a display screen of a user device at a time when the user's entity relationship management system (ERMS) has a recommendation for altering a second relationship of the user based upon the detection of an event associated with a first relationship of the user. For instance, a button on the top right of the screen display shows “relationship status—warm.” In one example, the button may be indicated in yellow, or some other color that is assigned to the “warn” status. For example, the button may remain green when there are no pending recommendations while turning yellow when one or more recommendations are pending.

Image 320 illustrates an example of what may be presented on the display screen of the user device when the user clicks on the button or otherwise selects to make the relationship management application “active.” As shown in image 320, a “relationship status summary” page/window is presented. The relationship status summary has a number of items such as “home,” “car,” “health,” “disability,” “life” as well as “employer,” “U.S. Treasury,” and “gym.” Notably, each of the items on the left side of the relationship status summary may relate to the user's relationship with various insurers, while those on the right hand side may relate to relationships with other entities. However, the present disclosure is not limited to any particular order of presentation and the organization of image 320, where insurer and non-insurer entities are segregated. In image 320, each of the items has a respective circle which may be shaded or colored in a similar manner. However, the circle for “car” is shaded or colored in a different manner as an indicator that a recommendation is pending for the user with respect to the user's relationship with the car insurer. Continuing with the previous example, the different shading/coloring of the circle for “car” provides a clear signal to the user that the cause for the warning in image 310 is related to the car insurer.

When the user clicks or otherwise selects one of the circles for a respective entity, the user may be taken to an additional page/window with details regarding the particular relationship. In the present example, the user may click on the circle for “car” and be provided with various details regarding the car insurance, as exemplified by image 330. For example, the page may provide a summary of the information deemed most relevant such as, the personal injury protection (PIP), uninsured motorist and comprehensive coverage limits for each vehicle, the deductible or deductibles, the monthly or annual premium, the date and amount of the next payment due, any safe driver discounts in effect, and so forth. Notably, a recommendation may also be provided with respect to altering the user's relationship with the car insurer. In one example, the recommendation may provide a recommended action and the reason for the recommendation, e.g., detection of a particular event with respect to another relationship of the user. For example, the user's ERMS may detect that the user has completed graduate school, determine that the user is eligible for a car insurance discount based upon this new status, and provide a recommendation to the user to request the discount. In one example, the recommendation also comprises a button that the user may select in order for the user's ERMS to automatically request from the relevant entity (e.g., the car insurer) to bring about the relationship change that was recommended.

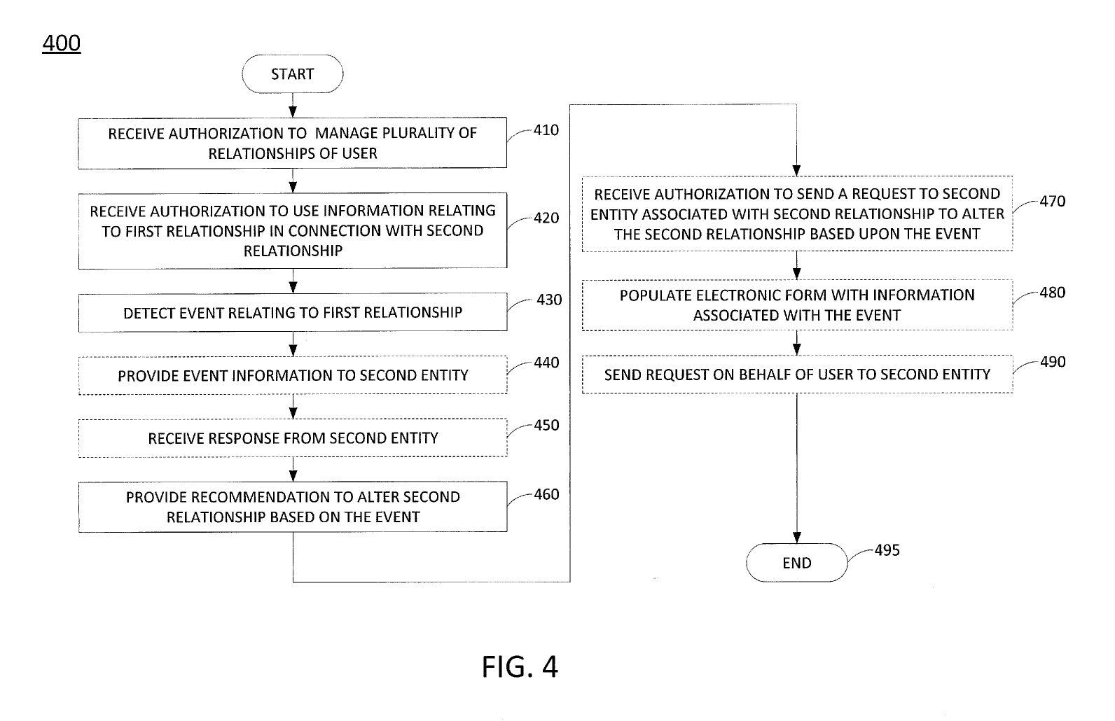

FIG. 4 illustrates an example flowchart of a method 400 for recommending an alteration to a second relationship based upon an event relating to a first relationship. In one embodiment, the steps, operations or functions of the method 400 may be performed by any one or more of the components of the system 100 depicted in FIG. 1 or the network 200 depicted in FIG. 2. For example, in one embodiment, the method 400 is performed by the user ERMS 104. In another embodiment, the method 400 is performed by the application server 204. Alternatively, or in addition, one or more steps, operations or functions of the method 200 may be implemented by a computing device having a processor, a memory and input/output devices as illustrated below in FIG. 5, specifically programmed to perform the steps, functions and/or operations of the method. Although any one of the elements in system 100 or network 200 may be configured to perform various steps, operations or functions of the method 400, the method will now be described in terms of an embodiment where steps of the method are performed by a processor, such as processor 502 in FIG. 5.

The method 400 begins at step 405 and proceeds to step 410. At step 410, the processor receives an authorization to manage a plurality of relationships of the user. For example, a user may have relationships with a number of vendors of products and services, including: insurance companies, an employer, governmental agencies, a gym, educational institutions, civic organizations, and so forth. In accordance with the present disclosure, the user may designate an entity relationship management system (ERMS) to manage one or more of these relationships, where each of these vendors may operate or be associated with an ERMS for interacting with the user's ERMS. Thus, in one example, the processor performing the method 400 comprises a processor of the user's ERMS. The authorization may be received from a device of the user in various formats including by way of a selection of one or more entities from a menu of available entities, by way of the user inputting a name, an identification code, or other identifier of an entity via a keyboard or other input device, and so forth.

At step 420, the processor receives an authorization to use information relating to a first relationship of the plurality of relationships in connection with a second relationship of the plurality of relationships. For example, the user may designate that information from certain relationships may only be shared with respect to certain other relationships. For instance, the user may allow his or her medical insurance information to be shared with his or her life insurance company's ERMS, but may not wish this information to be shared with his or her employer's ERMS.

At step 430, the processor detects an event relating to the first relationship. For example, the processor may access information regarding the user's salary from tax records obtained from an ERMS of a governmental agency or may access salary information from the ERMS of the user's employer to detect an event comprising a change in salary. In another example, the ERMS for the user's life insurance company may notify the processor that a new discount is offered to users who visit the gym more than 120 days per year. In another example, an ERMS for the user's car insurance company may notify the processor that discounts are available to customers with graduate degrees. It should be noted that the processor may detect an event by querying an ERMS of an entity periodically for new information pertaining to a relationship with the user, or may receive notifications from the ERMS when the EMRS determines to send the information. In another example, the processor may query the ERMS of an entity if a designated period of time has elapsed since new information was last received from the ERMS. Various other configurations of a similar nature may be employed in various embodiments. However, the processor at step 430 may also detect an event relating to the first relationship by receiving information directly from a device of the user. In one example, if the event relating to the first relationship changes a status of the user with respect to any parameters stored in a user profile, the processor may update the affected parameter or parameters of the user profile in accordance with the new status.

At optional step 440, the processor provides the event information to a second entity. For example, at step 430 the event may comprise a notification from an ERMS of the user's life insurance company that a new discount is offered to users who visit the gym more than 120 days per year. Thus, at step 440 the processor may query the ERMS for the user's gym to determine the user's current attendance record. Similarly, at step 430, the event may comprise a change in salary of the user. For example, the salary information may indicate that the user has a current salary of ‘X’, which is double the user's previous salary of ‘Y’. Thus, at step 440 the salary information may then be provided to the ERMS of the user's life insurance company, the homeowner's insurance company, and the like.

In still another example, the event at step 430 may comprise the user's car insurance company notifying the processor that a new discount is available to customers with graduate degrees. Thus, at step 440 the processor may query the ERMS of the user's graduate school to determine that the user has recently completed the degree program. Alternatively, the event at step 430 may comprise the processor determining that the user has recently been awarded a graduate degree, either by a “push” notification from an ERMS of the graduate school, or by a query the ERMS of the graduate school. In this case, step 440 may comprise the processor notifying the ERMS of the user's car insurer, life insurer, etc., of the change in the educational status of the user.

At optional step 450, the processor receives a response from the second entity. For instance, the ERMS for the life insurance company may respond that the user is over-insured or underinsured based upon his or her new salary information that was sent by the processor at step 440. In another example, an ERMS of the user's gym may respond as to the number of days in the current year that the user has attended the gym. In another example, the response may be received from an ERMS of an educational institution of the user and provide a current educational status of the user. In still another example, the response may be received from an insurer notifying the processor of a discount that the user qualifies for based upon the event information sent at step 440. For instance, the event notification may comprise a change in the educational level of the user, e.g., completion of a graduate degree, and the response at step 450 may comprise a notification that the user is eligible for a ten percent discount on car insurance as a customer with a master's degree.

At step 460, the processor provides a recommendation to the user to alter the second relationship with the second entity based upon the event. In one example, the recommendation is derived from a response received from the second entity at step 450. For instance, a response received at step 450 that indicates the user qualifies for a ten percent discount on car insurance may translate directly into a recommendation at step 460 that the user apply for or request the ten percent discount. In another example, where the response at step 450 comprises an indication from an ERMS of an insurer that the user is over or under-insured, the recommendation at step 460 may comprise a suggestion that the user contact the insurer to discuss adjusting the insurance coverage. In one example, the recommendation may further include a specific suggestion as to the recommended level of coverage. For example, the insurer may provide, in the response at step 450, a recommended level of coverage for an average user having the same set of parameters as the present user.

It should be noted, however, that the recommendation at step 460 does not necessarily comprise a simple pass-through of an offer or recommendation received from the second entity at step 450. For instance, at step 450 the processor may receive information on the user's attendance record from an ERMS of the user's gym. For example, the user may have attended the gym 110 days in the current year as of December 1. At step 460, the processor may further process this information in conjunction with the event notification information to determine that, since the user has attended the gym for 110 days, he or she only needs to attend the gym ten more times before the end of the year in order to qualify for the discount. Thus, the processor may recommend (i.e., as an alteration to the relationship with the gym) that the user attend at least ten more times in the current year or may simply populate a calendar of the user to schedule the attendance of the gym ten more times.

Similarly, since steps 440 and 450 may comprise optional steps, the processor may determine a recommendation to alter a second relationship based on the event without providing the event information to the second entity associated with the second relationship. For example, the processor may detect an event relating to a first relationship at step 430, may determine that the event changes a status of the user, and may compare the status of the user to any current relationships for which the processor is authorized to utilize such information, e.g., in order to determine whether a change in the relationship is recommended. To illustrate, the processor may have access to a program or a set of instructions, logic, and the like which fully or partially characterize an insurance product, such as the terms, the premium costs, and so forth for various combinations of user parameters. Thus, the processor may determine, for example, that the user qualifies for a lesser premium for the same coverage based upon a new status of the user, without having to query the insurer.

At optional step 470 the processor receives, e.g., from the user's device, an authorization to send a request to the second entity associated with the second relationship to alter the second relationship based on the event. For instance, the recommendation sent at step 460 may cause an application of the user's device to display a visual indicator and/or to present a different type of indicator that signifies a recommendation is pending. In turn, the user may navigate through one or more windows/pages to review details regarding the recommendation. In one example, the recommendation is visually presented as a button that the user may select, or a separate button is provided in connection with the visual presentation of recommendation. A selection of the button may cause an instruction to be sent to the processor to automatically request from the relevant entity (i.e., the ERMS of the second entity associated with the second relationship) to make the relationship change that was recommended. Notably, step 470 and subsequent steps 480 and 490, are considered optional steps insofar as the recommendation at step 460 may comprise a suggestion to the user to contact the second entity directly in order to adjust the second relationship. However, steps 470-490 are particularly advantageous insofar as the method 400 may automatically detect that a change in a second relationship is warranted and may automatically take an action to bring about the change with a simple click of a button by the user.

At optional step 480, the processor populates an electronic form with information associated with the event. For instance, if the recommendation at step 460 comprises a suggestion to apply for an insurance discount based upon a change in the status of the user with respect to a particular parameter of the user, the processor may fill an electronic form with various parameters relating to the user to apply for the discount. For example, the electronic form may comprise an electronic insurance quote form. In one example, the processor may notify an ERMS of the insurer that that an adjustment to an insurance policy is being requested with respect to a current insured (i.e., the user). As such, the ERMS of the insurer may provide an electronic form with the current information of the user, where the processor need only change fields/parameters affected by the change in status of the user as a result of the event detected at step 430.

At optional step 490 the processor sends the request on behalf of the user to the second entity. For example, the processor may send an electronic form completed at step 480, or may send a request in a different format to an ERMS of the second entity requesting the alteration to the second relationship. The ERMS of the second entity may then process the request and confirm the change with the processor and/or with the user, may contact the user to obtain further information, e.g., a signature, a verification of status, and the like, and to take further one or more actions to either complete or deny the request. Following step 490, the method 400 proceeds to step 495 where the method ends.

In addition, although not specifically specified, one or more steps, functions or operations of the method 400 may include a storing, displaying and/or outputting step as required for a particular application. In other words, any data, records, fields, and/or intermediate results discussed in the method 400 can be stored, displayed and/or outputted either on the device executing the method 400, or to another device, as required for a particular application.

Furthermore, steps, blocks, functions or operations in FIG. 4 that recite a determining operation or involve a decision do not necessarily require that both branches of the determining operation be practiced. In other words, one of the branches of the determining operation can be deemed as an optional step. In addition, one or more steps, blocks, functions or operations of the above described method 400 may comprise optional steps, or can be combined, separated, and/or performed in a different order from that described above, without departing from the example embodiments of the present disclosure.

The present disclosure may be extended to several additional embodiments. For instance, in another example, an event detected with respect to a first relationship may comprise a reassessment of a property value of a property of the user. The event may be detected via a notification or a query involving an ERMS of a governmental entity, e.g., a local tax assessor's office. In this case, the recommendation may comprise a recommendation for a change in an insurance coverage of the property of the user (in other words, a recommendation for an alteration to the user's relationship with the property insurer). For example, if the home on the property has recently been renovated and/or expanded and is assessed at a higher value than before, the property may be underinsured. Another example of a tax assessment change would occur if the user changed the user's official residence from a “town” house to the user's “lake” house, perhaps even renting out the user's town house. In this case, the user should remove the homestead exemption from the user's town house, and apply the homestead exemption to the user's new “homestead” at the lake. Thus, a recommendation can be presented to the user to bring about this change with respect to the homestead exemption.

As such, the present disclosure provides at least one advancement in the technical field of entity relationship management. This advancement is in addition to the traditional methods of a user making calendar notes to periodically review tax return and other financial information, insurance terms and conditions, coverage amounts and premium charges, and so forth. In particular, the present disclosure enables automatic detection of an event relating to a first relationship of a user and automatic recommendation of an alteration to a second relationship of the user based upon the event detected with respect to the first relationship.

The present disclosure also provides a transformation of data, e.g., a detected event with respect to a first relationship of a user, such as a change in a status of the user/change in a user parameter, or a change in a product offering from a vendor, are transformed into a recommendation for an alteration to a second relationship, which can then be further transformed into an automatic action to carry out the recommended alteration.

Finally, embodiments of the present disclosure improve the functioning of a computing device, e.g., a server. Namely, a server for providing relationship management services is improved by the use of information automatically obtained with respect to a first relationship to determine recommendations regarding alterations to a second relationship, and to automatically implement the recommended alterations, thereby providing a more robust relationship management process.

FIG. 5 depicts a high-level block diagram of a computing device suitable for use in performing the functions described herein. As depicted in FIG. 5, the system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for recommending an alteration to a second relationship based upon an event relating to a first relationship, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 400 as discussed above is implemented in a distributed or parallel manner for a particular illustrative example, i.e., the steps of the method, or the entire method is implemented across multiple or parallel computing devices, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

The one or more hardware processors 502 can also be configured or programmed to cause other devices to perform one or more operations as discussed above. In other words, the one or more hardware processors 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method. In one embodiment, instructions and data for the present module or process 505 for recommending an alteration to a second relationship based upon an event relating to a first relationship (e.g., a software program comprising computer-executable instructions) can be loaded into memory 504 and executed by hardware processor element 502 to implement the steps, functions or operations as discussed above in connection with the illustrative method 400. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for recommending an alteration to a second relationship based upon an event relating to a first relationship (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A method, comprising:
receiving, by a processor, an authorization to manage a plurality of relationships of a user;
detecting, by the processor, an event relating to a first relationship of the plurality of relationships; and
providing, by the processor, a recommendation to alter a second relationship of the plurality of relationships based on the event.

2. The method of claim 1, further comprising:
sending a request on behalf of the user to a device of a second entity associated with the second relationship to alter the second relationship based upon the event.

3. The method of claim 2, further comprising:
receiving an authorization from a device of the user to send the request.

4. The method of claim 2, further comprising:
populating an electronic form with information associated with the event relating to the first relationship, wherein the request that is sent comprises the electronic form.

5. The method of claim 1, wherein the event relating to the first relationship is detected via a device of a first entity that is associated with the first relationship.

6. The method of claim 5, further comprising:
providing information associated with the event to a device of a second entity associated with the second relationship; and
receiving a response from the device of the second entity, wherein the response comprises a notification of a potential change in the second relationship based upon the event, wherein the recommendation to alter the second relationship based on the event is derived from the response that is received from the device of the second entity.

7. The method of claim 5, wherein the event comprises a change in a salary of the user, wherein the first entity is an entity with access to salary information of the user, wherein the recommendation comprises a recommendation for a change in an insurance coverage of the user.

8. The method of claim 7, wherein the recommendation is further based upon information relating to the second relationship that is obtained via a device of a second entity that is associated with the second relationship, wherein the second entity comprises an insurer, wherein the information relating to the second relationship identifies a premium for the insurance coverage of the user based upon a plurality of factors, wherein the plurality of factors includes the salary of the user.

9. The method of claim 7, wherein the salary of the user is determined by the first entity from one of:
a tax record; or
a pay record.

10. The method of claim 7, wherein the first entity comprises:
an employer; or
a governmental agency.

11. The method of claim 5, wherein the event comprises a change in an educational degree level of the user, wherein the recommendation comprises a recommendation for a change in an insurance coverage of the user.

12. The method of claim 11, wherein the recommendation is further based upon information relating to the second relationship that is obtained via a device of a second entity that is associated with the second relationship, wherein the second entity comprises an insurer, wherein the information relating to the second relationship identifies a premium cost for the insurance coverage of the user based upon a plurality of factors, wherein the plurality of factors includes the educational degree level of the user.

13. The method of claim 5, wherein the first entity comprises a gym attended by the user, wherein the event comprises a number of visits to the gym by the user, wherein the recommendation comprises a recommendation to take an action to qualify for a discount on a premium for an insurance coverage of the user.

14. The method of claim 13, wherein the recommendation is further based upon information relating to the second relationship that is obtained via a device of a second entity that is associated with the second relationship, wherein the second entity comprises an insurer, wherein the information relating to the second relationship identifies the premium for the insurance coverage of the user based upon a plurality of factors, wherein the plurality of factors includes the number of visits to the gym by the user.

15. The method of claim 5, wherein the first entity comprises a governmental entity, wherein the event comprises a reassessment of a property value of a property of the user, wherein the recommendation comprises a recommendation for a change in an insurance coverage of the property of the user.

16. The method of claim 15, wherein the recommendation is further based upon information relating to the second relationship that is obtained via a device of a second entity that is associated with the second relationship, wherein the second entity comprises an insurer, wherein the information relating to the second relationship identifies the premium for the insurance coverage of the property of the user based upon a plurality of factors, wherein the plurality of factors includes the an assessed property value of the property of the user.

17. The method of claim 1, further comprising:
receiving an authorization to utilize the information relating to the first relationship in connection with the second relationship.

18. The method of claim 1, wherein each of the first relationship and the second relationship is associated with an entity comprising a vendor of a product or service.

19. A tangible a computer-readable medium storing instructions which, when executed by a processor, cause the processor to perform operations, the operations comprising:
receiving an authorization to manage a plurality of relationships of a user;
detecting an event relating to a first relationship of the plurality of relationships; and
providing a recommendation to alter a second relationship of the plurality of relationships based on the event.

20. A device, comprising:
a processor; and
a computer-readable medium storing instructions which, when executed by the processor, cause the processor to perform operations, the operations comprising:
receiving an authorization to manage a plurality of relationships of a user;
detecting an event relating to a first relationship of the plurality of relationships; and
providing a recommendation to alter a second relationship of the plurality of relationships based on the event.
